(19) United States
(12) Patent Application Publication
(10) Pub. No.: US 2017/0127225 A1
(43) Pub. Date: May 4, 2017

(54) SYSTEMS AND METHODS FOR DISTANCE BOUNDING USING NEAR FIELD COMMUNICATION

(71) Applicant: QUALCOMM Incorporated, San Diego, CA (US)

(72) Inventor: John Hillan, Alton (GB)

(21) Appl. No.: 15/334,557

(22) Filed: Oct. 26, 2016

Related U.S. Application Data
(60) Provisional application No. 62/248,130, filed on Oct. 29, 2015.

(51) Int. Cl. H04W 4/00; H04L 29/08

(52) U.S. Cl. CPC H04W 4/008; H04L 67/18; H04W 84/12

(57) ABSTRACT

A method for determining when to delay sending a response for distance bounding by a target device is described. The method includes receiving a challenge in a polling frame from a verifier device on a carrier signal for inductively coupled communication. The method also includes delaying a response adhering to rules of NFC type-A using a processing time multiplier. The method further includes sending the response to the verifier device in a listen frame.

### RELATED APPLICATIONS

This application is related to and claims priority from U.S. Provisional Patent Application Ser. No. 62/248,130, filed Oct. 29, 2015, for “SYSTEMS AND METHODS FOR DISTANCE BOUNDING USING NEAR FIELD COMMUNICATION.”

### TECHNICAL FIELD

The present disclosure relates generally to communications. More specifically, the present disclosure relates to systems and methods for distance bounding using near field communication (NFC).

### BACKGROUND

Advances in technology have resulted in smaller and more powerful personal computing devices. For example, there currently exist a variety of portable personal computing devices, including wireless computing devices, such as portable wireless telephones, personal digital assistants (PDAs) and paging devices that are each small, lightweight and can be easily carried by users. More specifically, the portable wireless telephones, for example, further include cellular telephones that communicate voice and data packets over wireless networks. Many such cellular telephones are being manufactured with relatively large increases in computing capabilities, and as such, are becoming tantamount to small personal computers and hand-held PDAs. Further, such devices are being manufactured to enable communications using a variety of wired and wireless communication technologies. For example devices may perform cellular communications, wireless local area network (WLAN) communications, near field communication (NFC), fiber optic communication, etc.

In some scenarios, communication between a verifier device and a target device may use NFC. Furthermore, the verifier device and the target device may rely on the distance between the devices. For example, security may be enhanced if an accurate upper bound on the distance between devices is known. Benefits may be realized for determining a distance upper bound between devices using near field communication (NFC).

### SUMMARY

A method for determining when to delay sending a response for distance bounding by a target device is described. The method includes receiving a challenge in a polling frame from a verifier device on a carrier signal for inductively coupled communication. The method also includes delaying a response adhering to rules of NFC type-A using a processing time multiplier. The method further includes sending the response to the verifier device in a listen frame.

Delaying the response using a processing time multiplier may include delaying a start of load modulation of the carrier signal within a tolerance window of the listen frame based on the processing time multiplier. The start of load modulation may be delayed by a number of carrier cycles corresponding to the processing time multiplier. The processing time multiplier may be a number of carrier cycles that the target device delays the start of load modulation of the response.

The tolerance window may be a frame delay time (FDT) delta. The response may start within the tolerance window beginning at a bit boundary defined by the verifier device.

Delaying the response using a processing time multiplier may include adjusting a number of bit durations before sending the response based on the processing time multiplier. Load modulation of the response may occur in the listen frame after the number of bit durations indicated by the processing time multiplier. Load modulation of the response may be shifted by the number of bit durations indicated by the processing time multiplier.

The number of bit durations may correspond to a frame delay time (FDT) before the listen frame. The response may occur in a bit grid defined by the verifier device. The inductively coupled communication may be near field communication (NFC).

A target device configured to determine when to delay sending a response for distance bounding is also described. The target device includes a processor, a memory in communication with the processor and instructions stored in the memory. The instructions are executable by the processor to receive a challenge in a polling frame from a verifier device on a carrier signal for inductively coupled communication. The instructions are also executable to delay a response adhering to rules of NFC type-A using a processing time multiplier. The instructions are further executable to send the response to the verifier device in a listen frame.

A computer-program product is also described. The computer-program product includes a non-transitory computer-readable medium having instructions thereon. The instructions include code for causing a target device to receive a challenge in a polling frame from a verifier device on a carrier signal for inductively coupled communication. The instructions also include code for causing the target device to delay a response adhering to rules of NFC type-A using a processing time multiplier. The instructions further include code for causing a target device to send the response to the verifier device in a listen frame.

An apparatus is also described. The apparatus includes means for receiving a challenge in a polling frame from a verifier device on a carrier signal for inductively coupled communication. The apparatus also includes means for delaying a response adhering to rules of NFC type-A using a processing time multiplier. The apparatus further includes means for sending the response to the verifier device in a listen frame.

A method for distance bounding by a verifier device is also described. The method includes sending a challenge in a polling frame to a target device on a carrier signal for inductively coupled communication. The method also includes receiving a response from the target device in a listen frame. The target device delays the response adhering to rules of NFC type-A using a processing time multiplier. The method further includes calculating a distance upper bound based on the processing time multiplier and a round-trip time to send the challenge to the target device and receive the response.

A verifier device configured for distance bounding is also described. The verifier device includes a processor, a memory in communication with the processor and instructions stored in the memory. The instructions are executable by the processor to send a challenge in a polling frame to a target device on a carrier signal for inductively coupled communication. The instructions are also executable to receive a response from the target device in a listen frame. The target device delays the response adhering to rules of NFC type-A using a processing time multiplier. The instructions are further executable to calculate a distance upper bound based on the processing time multiplier and a round-trip time to send the challenge to the target device and receive the response.

A computer-program product is also described. The computer-program product includes a non-transitory computer-readable medium having instructions thereon. The instructions include code for causing a verifier device to send a challenge in a polling frame to a target device on a carrier signal for inductively coupled communication. The instructions also include code for causing the verifier device to receive a response from the target device in a listen frame. The target device delays the response adhering to rules of NFC type-A using a processing time multiplier. The instructions further include code for causing the verifier device to calculate a distance upper bound based on the processing time multiplier and a round-trip time to send the challenge to the target device and receive the response.

An apparatus is also described. The apparatus includes means for sending a challenge in a polling frame to a target device on a carrier signal for inductively coupled communication. The apparatus also includes means for receiving a response from the target device in a listen frame. The target device delays the response adhering to rules of NFC type-A using a processing time multiplier. The apparatus further includes means for calculating a distance upper bound based on the processing time multiplier and a round-trip time to send the challenge to the target device and receive the response.

### BRIEF DESCRIPTION OF THE DRAWINGS

FIG. 1 is a block diagram illustrating one configuration of a communication system distance bounding using near field communication (NFC);

FIG. 2 is a diagram illustrating a first approach for distance bounding using NFC;

FIG. 3 is a diagram illustrating a second approach for distance bounding using NFC;

FIG. 4 is a flow diagram illustrating a method for distance bounding by a verifier device using NFC;

FIG. 5 is a flow diagram illustrating a method for distance bounding by a target device using NFC;

FIG. 6 is a flow diagram illustrating another method for distance bounding by a verifier device using NFC;

FIG. 7 is a flow diagram illustrating another method for distance bounding by a target device using NFC;

FIG. 8 is a sequence diagram illustrating an approach for calculating transit time according to the described systems and methods; and

FIG. 9 illustrates certain components that may be included within an electronic device.

### DETAILED DESCRIPTION

In certain situations, it is advantageous for a device to be able to determine an upper bound for the distance to another device. For example, it may be beneficial in a security context to ascertain that a building access badge is physically close to a door reader. Signal strength measurements tend to have a wide variance that makes accurate determination of distance hard to accomplish, and by manipulating the transmitter it is possible for a malicious device to pretend to be closer than the actual separation.

According to the systems and methods described herein, a verifier device may use a round-trip delay for a signal to measure the transit time of the signal. From the transit time measurement, the verifier device may determine an upper bound on the distance to the target device. Because nothing can travel faster than the speed of light, a signal (e.g., radio signal) can reliably be used to place an upper bound on the distance to the target device. The target device might be closer, but it cannot be farther away.

It should be noted that some communication devices may communicate wirelessly and/or may communicate using a wired connection or link. For example, some communication devices may communicate with other devices using an Ethernet protocol. The systems and methods disclosed herein may be applied to communication devices that communicate wirelessly and/or that communicate using a wired connection or link. In one configuration, the systems and methods disclosed herein may be applied to a communication device that communicates with another device using near field communication (NFC).

The detailed description set forth below in connection with the appended drawings is intended as a description of exemplary implementations of the disclosure and is not intended to represent the only implementations in which the disclosure may be practiced. The term “exemplary” used throughout this description means “serving as an example, instance or illustration,” and should not necessarily be construed as preferred or advantageous over other exemplary implementations. The detailed description includes specific details for the purpose of providing a thorough understanding of the exemplary implementations of the disclosure. In some instances, some devices are shown in block diagram form.

While for purposes of simplicity of explanation, the methodologies are shown and described as a series of acts, it is to be understood that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

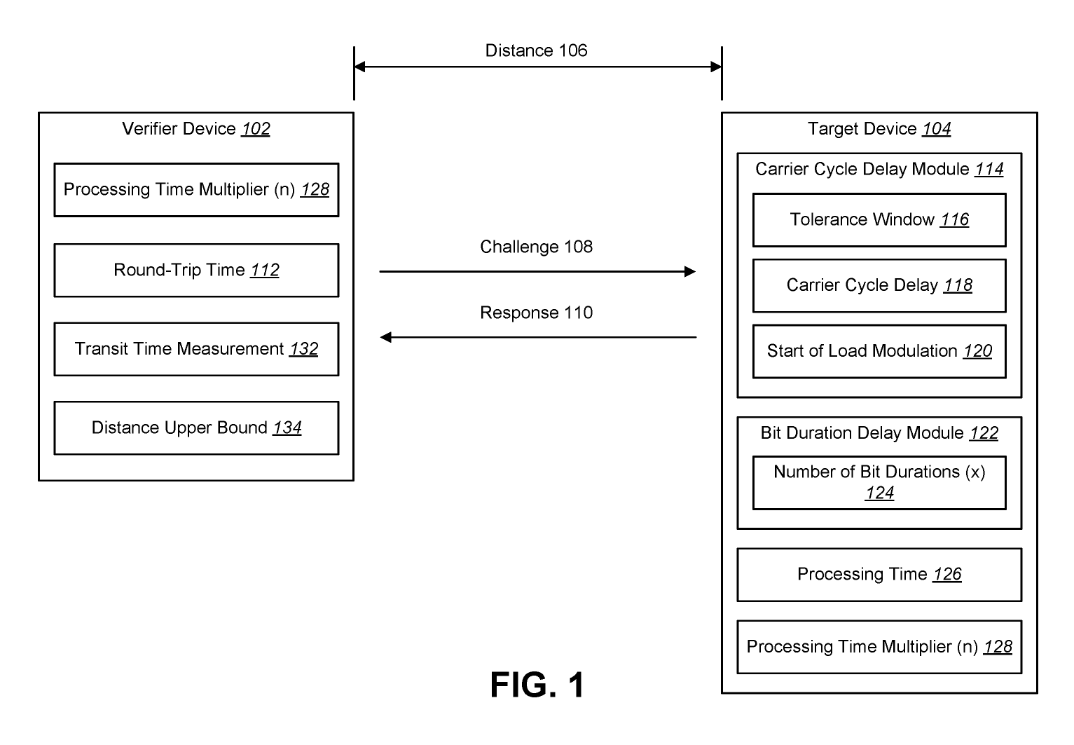

FIG. 1 is a block diagram illustrating one configuration of a communication system 100 for distance bounding using near field communication (NFC). The communication system 100 may include a verifier device 102 and a target device 104. The verifier device 102 or the target device 104 may also be referred to as an electronic communication device, mobile device, mobile station, subscriber station, client, client station, user equipment (UE), remote station, access terminal, mobile terminal, terminal, user terminal, subscriber unit, etc. Examples of devices include laptop or desktop computers, card readers, cellular phones, smart phones, wireless modems, e-readers, tablet devices, gaming systems, etc. Some of these devices may operate in accordance with one or more industry standards.

The verifier device 102 and the target device 104 may communicate using one or more communication technologies. These communication technologies may include wired communication technologies and wireless communication technologies.

The verifier device 102 and the target device 104 may communicate using one or more communication technologies that operate at the speed of light. These technologies may include, but are not limited to, radio frequency (RF), visible light (“LiFi”), microwave, infrared communication, electrical connection and/or magnetic coupling.

In a configuration, the verifier device 102 and the target device 104 may operate in accordance with certain industry standards, such as Third Generation Partnership Project (3GPP) Long Term Evolution (LTE) standards. Other examples of standards that a communication device may comply with include Institute of Electrical and Electronics Engineers (IEEE) 802.11a, 802.11b, 802.11g, 802.11n and/or 802.11ac (e.g., Wireless Fidelity or “Wi-Fi”) standards, Bluetooth, IEEE 802.16 (e.g., Worldwide Interoperability for Microwave Access or “WiMAX”) standards, Code Division Multiple Access (CDMA) 2000 1× (referred to herein as “1×”, may also be referred to as IS-2000 or 1×RTT) standards, Evolution-Data Optimized (EVDO) standards, Interim Standard 95 (IS-95), High Data Rate (HDR), High Rate Packet Data (HRPD), evolved High Rate Packet Data (eHRPD), radio standards and others. A wireless wide area network (WWAN) may include Wireless Metropolitan Area Networking (WMAN) standards and High-Speed Downlink Packet Access (HSDPA) standards. While some of the systems and methods disclosed herein may be described in terms of one or more standards, this should not limit the scope of the disclosure, as the systems and methods may be applicable to many systems and/or standards.

In another configuration, the verifier device 102 and the target device 104 may communicate using inductively coupled communication. In one implementation of inductively coupled communication, the verifier device 102 and the target device 104 may use near field communication (NFC). In another implementation, the verifier device 102 and the target device 104 may use radio-frequency identification (RFID). In this configuration, the verifier device 102 may be a reader/writer and the target device 104 may be a listening device. For example, the verifier device 102 may be an NFC reader/writer and the target device 104 may be an NFC card.

The verifier device 102 and the target device 104 may be separated by a distance 106. In certain situations, it may be advantageous to be able to determine a distance upper bound 134 from a verifier device 102 to a target device 104. This becomes especially important when attempting to verify that a device (i.e., the target device 104) being presented to another device (i.e., the verifier device 102) for a transaction is physically close in order to thwart relay attacks.

Normal security protocols, such as for building access or payment, only verify that a device being presented is able to respond correctly to one or more challenges 108. However, it is possible to circumvent this by relaying the challenge 108 to a genuine device, then relaying the response 110 back to the device under attack. When considering that all that would be needed is a pair of devices (e.g., smart phones) with a malicious program to perform this relay, the potential number of attacks is significant.

If the device under attack (e.g., the verifier device 102) is able to determine that the device being presented (e.g., the target device 104) is physically close, this type of attack becomes far more difficult. A number of approaches have been proposed but all suffer from drawbacks. In one approach, distance 106 may be determined based on signal strength measurements. However, signal strength measurements tend to have a wide variance that makes accurate determination of distance 106 hard to accomplish. Furthermore, by manipulating a transmitter, it is possible to pretend to be closer than the actual separation.

Another approach is to use the round-trip delay (i.e., transit time) for a signal. As used herein, “transit time” refers to the amount of time it takes for a signal to travel between two points. For example, the transit time for a signal sent by the verifier device 102 to the target device 104 is the amount of time for the signal to reach the target device 104 once the verifier device 102 transmits the signal. Transit time may also be referred to as time-of-flight, time interval, flight time or other equivalent terms.

Since nothing can travel faster than the speed of light, a signal (e.g., radio or light signal) can reliably be used to place an upper bound on the distance 106 (i.e., distance upper bound 134) from the verifier device 102 to the target device 104. The target device 104 might be closer, but it cannot be farther away than the distance upper bound 134.

One drawback to this approach is that communication transit times are extremely short, especially when trying to establish location to human dimensions. Even a 1 nanosecond (ns) round trip corresponds to a separation of 15 centimeters (cm). This means that any processing delay in the remote device can quickly swamp the transit time and lead to huge uncertainty in the distance upper bound 134 measurement.

The systems and method described herein provide for eliminating the effects of the processing delay in the remote device when performing a distance upper bound 134 determination operation. This may allow for more accurate distance 106 measurements.

When applied to near field communication (NFC) there are some aspects that can restrict the ability of the responding device (i.e., target device 104) to perform processing delay scaling. The systems and methods described herein provide for distance bounding using NFC.

When using active communication mode (ACM), the responding device (i.e., target device 104) has no fine-scale limitations on when it can choose to respond. In active communication mode, the responding device has a large window in which to respond. Thus, the responding device can implement processing delay scaling quite simply by varying the time at which it turns on its own field, by varying the time at which it starts the modulation for its response 110, or some combination of the two.

When using passive communication mode (PCM), the responding device is limited at the fine-scale by the need to use the carrier wave from the challenging device (e.g., verifier device 102). For NFC-B, NFC-F, and NFC-V, there is sufficient flexibility between the minimum and maximum delay times in which the responding device can choose to start the load modulation for its response 110. However, for NFC-A the responding device is further restricted to the bit grid established by the polling device.

For NFC-A, there are two requirements on the start of a response 110 (e.g., a listen frame). These requirements are relevant when considering distance bounding using the processing delay scaling method. For the first requirement, the response 110 must start at a bit boundary as defined by the device sending the challenge 108 (e.g., a polling frame) with a small tolerance. For the second requirement, the device sending the response 110 does not have to use the same number of bit durations 124 after successive polling frames.

The systems and methods described herein provide two approaches by which the responding target device 104 can achieve the processing delay scaling while adhering to the rules of NFC-A. A first approach is to vary the number of carrier cycles to the start of load modulation 120 within the allowed delta for the frame delay time (FDT). A second approach is to vary the number of bit durations (x) 124, which has the effect of shifting the load modulation for the response 110 by a number of bit positions.

The verifier device 102 may determine a distance upper bound 134 based in part on a round-trip time measurement 112 that is delayed by a processing time multiplier 128. The processing time multiplier 128 indicates an amount of time that the target device 104 delays responding to a challenge 108 sent by the verifier device 102.

The processing time multiplier 128 may be communicated to the target device 104. In an implementation, the verifier device 102 may send the processing time multiplier 128 to the target device 104. The processing time multiplier 128 may be sent in an encrypted or unencrypted format. For example, the verifier device 102 and the target device 104 may establish a shared secret (e.g., shared key) with which the processing time multiplier 128 is encrypted and decrypted. In another implementation, the verifier device 102 may send a bounding sequence from which the processing time multiplier 128 is derived.

The target device 104 may include a carrier cycle delay module 114, a bit duration delay module 122 or both. As used herein, a module may be implemented as hardware (e.g., circuitry), software executed by a processor, or both hardware and software.

The carrier cycle delay module 114 may implement the first approach for distance bounding. In this first approach, the target device 104 may receive a challenge 108 in a polling frame from the verifier device 102. The polling frame may be sent on a carrier signal for inductively coupled communication (e.g., NFC).

Upon receiving the challenge 108, the carrier cycle delay module 114 may delay a start of load modulation 120 of the carrier signal within a tolerance window 116 of a listen frame. The carrier cycle delay 118 may be based on the processing time multiplier 128. In NFC-A, the first carrier cycle to be load modulated can be varied within an allowed tolerance window 116, referred to here as FDT delta.

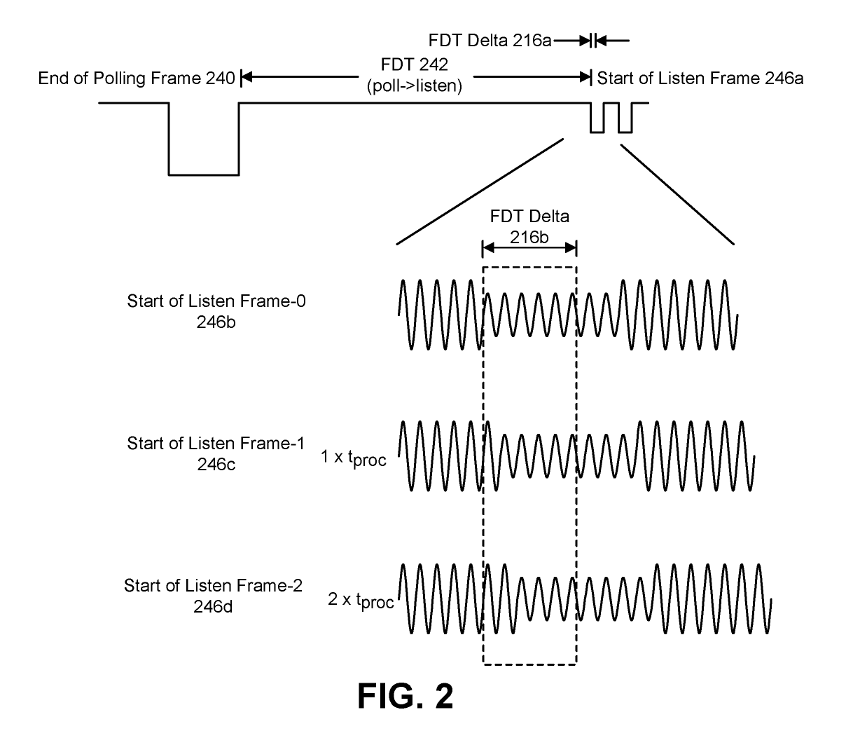

The carrier cycle delay module 114 may delay the start of load modulation 120 by applying a carrier cycle delay 118. The carrier cycle delay 118 is a number of carrier cycles corresponding to the processing time multiplier 128. In an implementation, the processing time multiplier 128 is the number of carrier cycles that the target device 104 delays the start of load modulation 120 of the response 110. This approach is further described in connection with FIG. 2.

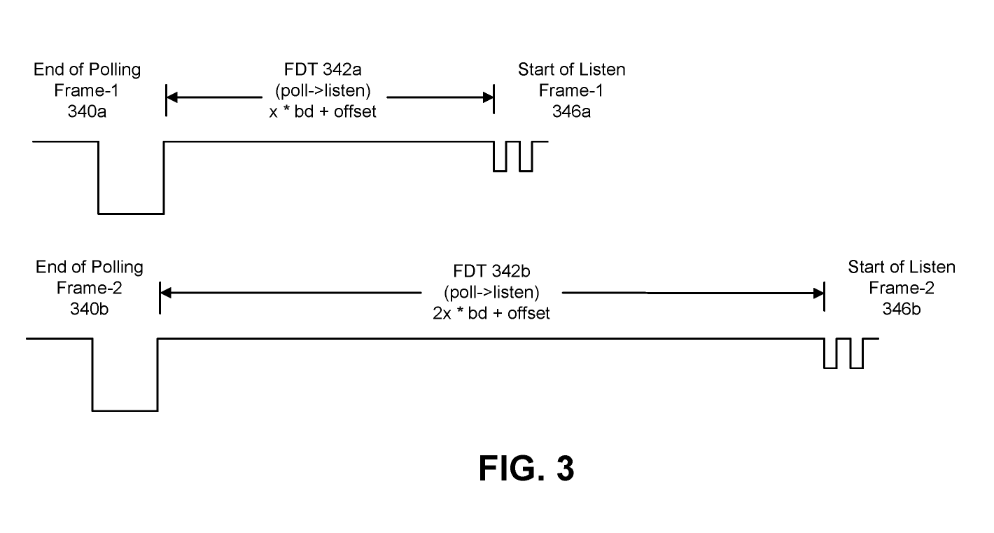

The bit duration delay module 122 may implement the second approach for distance bounding. As described above, the target device 104 may receive a challenge 108 in a polling frame from the verifier device 102. The bit duration delay module 122 may adjust the number of bit durations (x) 124 before sending a response 110 based on a processing time multiplier 128. The number of bit durations 124 may correspond to the frame delay time (FDT) before the listen frame. In this approach, the bit duration delay module 122 may vary the number of bit durations 124 between the challenge 108 and the response 110. For example, the bit duration delay module 122 may multiply the number of bit durations (x) 124 by the processing time multiplier (n) 128. This results in the load modulation for the response 110 being shifted by the number of bit durations 124 indicated by the processing time multiplier 128. This approach is further described in connection with FIG. 3.

It should be noted that the two approaches are not exclusive. For example, the target device 104 may vary both the start of load modulation 120 within the tolerance window 116 (e.g., FDT Delta) and the number of bit durations (x) 124 for a given response 110.

It should be further noted that other NFC technologies (e.g., NFC-B, NFC-F, NFC-V) with fewer restrictions on the start of the load modulation of the response 110 can still make use of either or both of the approaches described here for NFC-A.

Upon receiving the response 110, the verifier device 102 may calculate a distance upper bound 134 based on the processing time multiplier 128 and a round-trip time 112 to send the challenge 108 to the target device 104 and receive the response 110. A round-trip time 112 may include the transit time for sending a challenge 108 to the target device 104, a processing time 126 by the target device 104 and the transit time to receive a response 110 from the target device 104.

The processing time 126 may be the amount of time that the target device 104 takes to process the challenge 108 received from the verifier device 102. The processing time 126 may also be referred to as a processing delay. For example, the processing time 126 is the amount of time that the target device 104 takes to process the challenge 108, generate a response 110 and send the response 110. The round-trip time 112 may be expressed according to Equation (1).

T_{round,1}=T_{proc}+2·T_{f} (1)

In Equation (1), T_{round,1} is the round-trip time 112, T_{proc} is the processing time 126 for the target device 104 to process the first challenge 108 and T_{f} is the transit time that is multiplied by 2 due to the verifier device 102 sending the challenge 108 and receiving the response 110.

In a second challenge/response exchange, the target device 104 may delay the response 110 according to a processing time multiplier 128. In this exchange, the verifier device 102 may measure a second round-trip time 112 that includes the transit time for sending a second challenge 108 to the target device 104, a processing time multiplier 128 (n) applied by the target device 104 and the transit time to receive a second response 110 from the target device 104.

The processing time multiplier 128 indicates an amount of time that the target device 104 delays responding to a challenge 108 sent by the verifier device 102. Upon receiving the second challenge 108, the target device 104 may scale the processing time 126 by the processing time multiplier 128 before responding to the second challenge 108. This may be accomplished according to one or both of the two approaches described above. The second round-trip time 112 may be expressed according to Equation (2).

T_{round,n}=n·T_{proc}+2·T_{f} (2)

In Equation (2), T_{round,n} is the second round-trip time 112, and n is the processing time multiplier 128 for the target device 104 to process the second challenge 108. Once again, the transit time T_{f} is multiplied by 2 due to the verifier device 102 sending the second challenge 108 and receiving the second response 110.

The verifier device 102 may determine a transit time measurement 132 based on the first round-trip time 112, the second round-trip time 112 and the processing time multiplier 128 (n). Because the processing time multiplier 128 (n) represents the scale factor for the target device 104 (e.g., a card) to use in its processing time 126 delay, the transit time measurement 132 T_{f} may be determined according to the following equations. Multiplying the first round-trip time 112 by the processing time multiplier 128 (n) results in

$$\begin{matrix}n \cdot {T}_{round , 1} = n \cdot {T}_{proc} + 2 n \cdot {T}_{f} . & ( 3 ) \\ \begin{matrix}n \cdot {T}_{round , 1} - {T}_{round , n} = n \cdot {T}_{proc} + 2 n \cdot {T}_{f} - n \cdot {T}_{proc} - 2 \cdot {T}_{f} \\ = 2 n \cdot {T}_{f} - 2 \cdot {T}_{f} \\ = 2 {T}_{f} ( n - 1 )\end{matrix} & ( 4 ) \\ {T}_{f} = \frac{n \cdot {T}_{round , 1} - {T}_{round , n}}{2 ( n - 1 )} & ( 5 )\end{matrix}$$

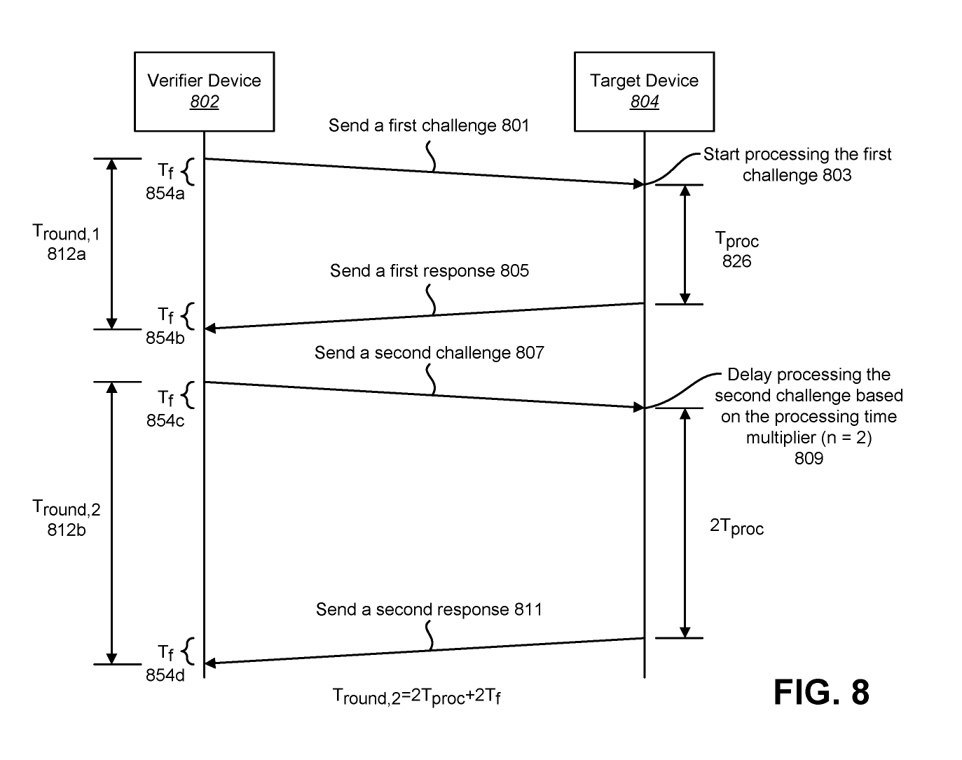

It should be noted that according to Equation (5), the verifier device 102 (e.g., reader/writer) may calculate the transit time independent of the actual processing time 126 of the target device 104. In other words, the verifier device 102 need not know the processing time 126 of the target device 104 to determine the transit time measurement 132. Although the target device 104 must be able to scale its processing time 126 accurately, this approach does not rely on this processing time 126 being short. FIG. 8 illustrates an example where the processing time multiplier 128 (n) is 2.

The verifier device 102 may determine a distance upper bound 134 between the verifier device 102 and the target device 104 based on the transit time measurement 132. Once the transit time measurement 132 (T_{f}) is determined to the desired accuracy, the verifier device 102 may determine the distance upper bound 134 by multiplying the transit time measurement 132 by the speed of light (c). The distance upper bound 134 may be expressed as T_{f}·c.

This distance upper bound 134 may be an upper bound of a measure of the distance 106 (or separation) between the verifier device 102 and the target device 104. Therefore, the verifier device 102 and the target device 104 may be closer than the distance upper bound 134, but the verifier device 102 and the target device 104 cannot be farther apart.

By repeating the round-trip time 112 measurements multiple times, minor fluctuations in the processing delay may be averaged out, improving the accuracy of the transit time measurement 132 still further. Therefore, in an implementation, the verifier device 102 may determine the distance upper bound 134 based on at least one additional transit time measurement 132 in which the target device 104 delays its response 110 according to the processing time multiplier 128.

In this implementation, the verifier device 102 may measure at least one additional round-trip time 112 to receive a response 110 from the target device 104. The response 110 from the target device 104 may or may not be delayed by the processing time multiplier 128. Furthermore, the processing time multiplier 128 used in the one or more round-trip time 112 measurements may be the same value, or may be a different value. In other words, the processing time multiplier 128, in this implementation, may be a sequence of values that are applied for a given round-trip time 112 measurement. For example, in one round-trip time 112 measurement the processing time multiplier 128 may be 2, while in another round-trip time 112 measurement the processing time multiplier 128 may be 3.

The verifier device 102 may then determine at least one additional transit time measurement 132 using the at least one additional round-trip time 112. For each round-trip time 112 measurement, the verifier device 102 may determine a transit time measurement 132 according to Equation (5). The verifier device 102 may determine an average transit time measurement 132 using each of the multiple transit time measurements 132. The verifier device 102 may determine the distance upper bound 134 by multiplying the average transit time measurement 132 by the speed of light.

The processing time multiplier 128 may be known by the verifier device 102 and the target device 104 but not known to other devices. The manner for determining the processing time multiplier 128 to apply for a given response 110 can be chosen to suit the needs of a particular application. In one implementation, for a simple, non-secure establishment of the distance upper bound 134 measurement, a fixed sequence of the processing time multiplier 128 (n) could be used, such as 2-2-2-2, or 2-3-4-2-3-4. Additional non-delayed responses 110 can be included at any predetermined location, if desired.

FIG. 2 is a diagram illustrating a first approach for distance bounding using NFC. In this first approach, a target device 104 may vary the number of carrier cycles to the start of load modulation 120 within the allowed variance (delta) for the frame delay time (FDT) 242.

The top part of FIG. 2 shows a representation of the end of a polling frame 240 and the start of a listen frame 246a. The time between the polling frame and the start of the listen frame 246a is characterized by a frame delay time (FDT) 242. FDT Delta 216 is an allowed tolerance window 116 for the start of the listen frame 246a.

The lower part of FIG. 2 shows a zoom into the start of the load modulation of the response 110 overlaid with FDT Delta 216b. FDT Delta 216b is large enough to allow the start of load modulation 120 to be varied by several carrier cycles. The beginning of the FDT Delta 216b represents the start of the bit grid defined by the verifier device 102. The response 110 from the target device 104 occurs within FDT Delta 216b beginning at this bit boundary.

Three listen frames 246 are depicted (with the end of polling frame omitted for clarity). The start of listen frame-0 246b shows a non-delayed response 110. In this case, the start of load modulation 120 occurs without any carrier cycle delay 118.

The start of listen frame-1 246c shows the application of a processing time multiplier 128 of 1. In this case, the start of load modulation 120 occurs after a carrier cycle delay 118 of 1 carrier cycle. This processing time delay may be expressed as 1×T_{proc}.

The start of listen frame-2 246d shows the application of a processing time multiplier 128 of 2. In this case, the start of load modulation 120 occurs after a carrier cycle delay 118 of 2 carrier cycles. This processing time delay may be expressed as 2×T_{proc}.

In this approach, the processing time multiplier 128 is the number of carrier cycles that the target device 104 delays the start of load modulation 120 of the response 110. It should be noted that the carrier cycle delay 118 may be limited by the size of the tolerance window 116. In an implementation, the carrier cycle delay 118 may be an integer value between 0-4 carrier cycles.

FIG. 3 is a diagram illustrating a second approach for distance bounding using NFC. In this second approach, a target device 104 may vary the number of bit durations 124 between a challenge 108 and a response 110.

The top part of FIG. 3 shows a representation of the end of a first polling frame 340a and the start of a first listen frame 346a. The time between the polling frame 340a and the start of the listen frame 346a is characterized by a frame delay time (FDT) 342a. The FDT 342a includes a value “x” being used for the number of bit durations 124 prior to sending the response 110. The term “bd” is the bit duration. The FDT 342a may also include an offset, which may be a fixed value.

In this first case, the processing time multiplier 128 is 1. Load modulation of the response 110 occurs at the start of listen frame-1 346a after the number of bit durations 124 indicated by the processing time multiplier 128. Because the processing time multiplier 128 is 1, the number of bit durations 124 is unchanged. Therefore, the FDT 342a for this first example is x·bd+offset.

The bottom part of FIG. 3 shows the end of a second polling frame 340b and the start of a second listen frame 346b, with a value “2x” being used for the number of bit durations 124 prior to sending the response 110. Therefore, the FDT 342b for this second example is 2x·bd+offset.

In this second case, the processing time multiplier 128 is 2. Therefore, the number of bit durations 124 is doubled. The load modulation for the response 110 is shifted by the number of bit durations 124 indicated by the processing time multiplier 128.

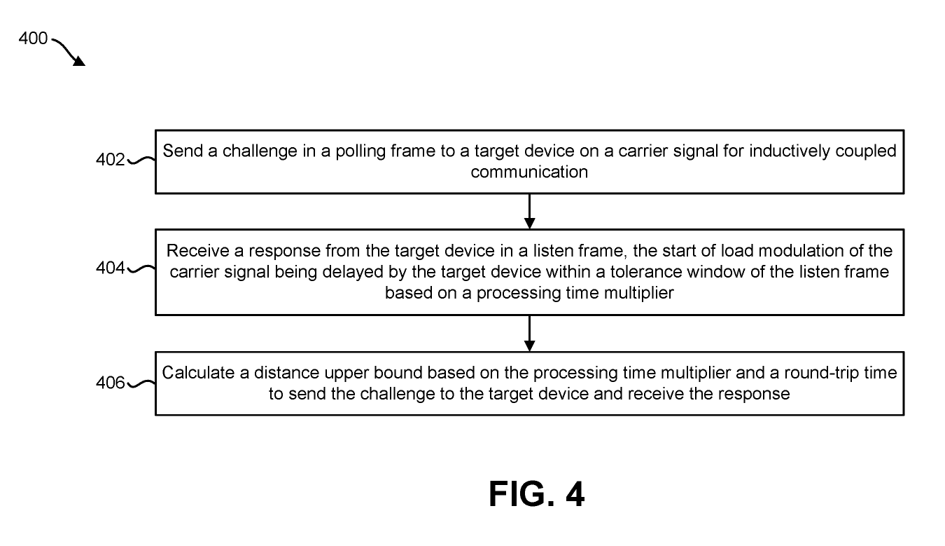

FIG. 4 is a flow diagram illustrating a method 400 for distance bounding by a verifier device 102 using NFC. The method 400 may be performed by a verifier device 102 that is in communication with a target device 104. In an implementation, the verifier device 102 may be a reader device (e.g., reader/writer) and the target device 104 may be listening device (e.g., card). The method 400 is an implementation of the first approach for distance bounding using NFC described above.

The verifier device 102 may send 402 a challenge 108 in a polling frame 240 to a target device 104 on a carrier signal for inductively coupled communication. The inductively coupled communication may be near field communication (NFC).

The verifier device 102 may receive 404 a response 110 from the target device 104 in a listen frame 246. The target device 104 may delay a start of load modulation 120 of the carrier signal within a tolerance window 116 of the listen frame based on a processing time multiplier 128. In an implementation, the tolerance window 116 may be a frame delay time (FDT) delta 216. The response 110 may start within the tolerance window 116 beginning at a bit boundary defined by the verifier device 102. The response 110 may be delayed adhering to the rules of NFC type-A (NFC-A).

The target device 104 may delay the start of load modulation 120 by a number of carrier cycles corresponding to the processing time multiplier 128. In an implementation, the processing time multiplier 128 may be the number of carrier cycles that the target device 104 delays starting load modulation of the response 110.

The verifier device 102 may calculate 406 a distance upper bound 134 based on the processing time multiplier 128 and a round-trip time 112 to send the challenge 108 to the target device 104 and receive the response 110. This may be accomplished as described in connection with FIG. 1.

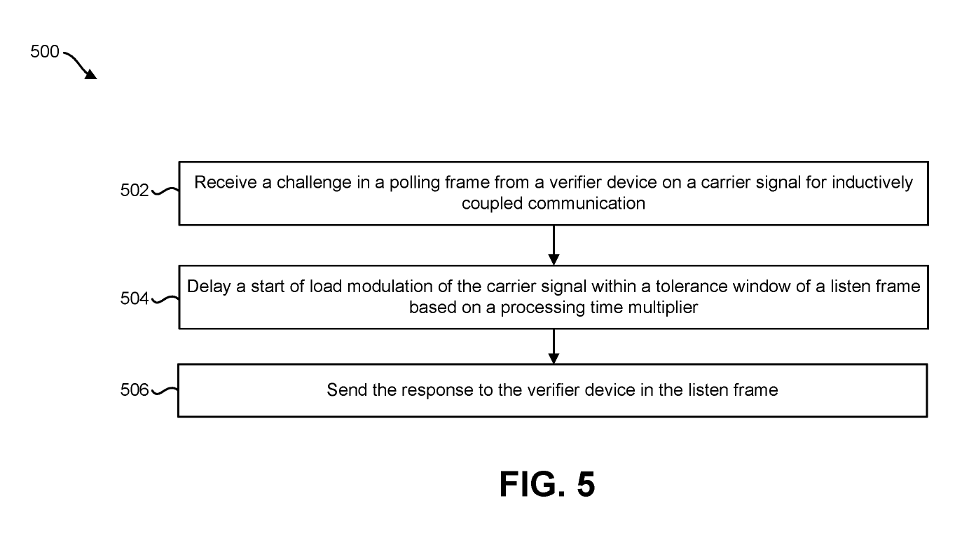

FIG. 5 is a flow diagram illustrating a method 500 for distance bounding by a target device 104 using NFC. The method 500 may be performed by a target device 104 that is in communication with a verifier device 102. In an implementation, the verifier device 102 may be a reader device (e.g., reader/writer) and the target device 104 may be listening device (e.g., card). The method 500 is an implementation of the first approach for distance bounding using NFC described above.

The target device 104 may receive 502 a challenge 108 in a polling frame 240 from a verifier device 102 on a carrier signal for inductively coupled communication. The inductively coupled communication may be near field communication (NFC).

The target device 104 may delay 504 a start of load modulation 120 of the carrier signal within a tolerance window 116 of a listen frame 246 based on a processing time multiplier 128. In an implementation, the tolerance window 116 may be a frame delay time (FDT) delta 216. The response 110 may start within the tolerance window 116 beginning at a bit boundary defined by the verifier device 102. The response 110 may be delayed while adhering to the rules of NFC type-A (NFC-A).

The target device 104 may delay 504 the start of load modulation 120 by a number of carrier cycles corresponding to the processing time multiplier 128. In an implementation, the processing time multiplier 128 may be the number of carrier cycles that the target device 104 delays starting load modulation of the response 110.

The target device 104 may send 506 a response 110 to the verifier device 102 in the listen frame 246. For example, the target device 104 may start load modulation of the carrier signal upon expiration of the carrier cycle delay 118 as indicated by the processing time multiplier 128.

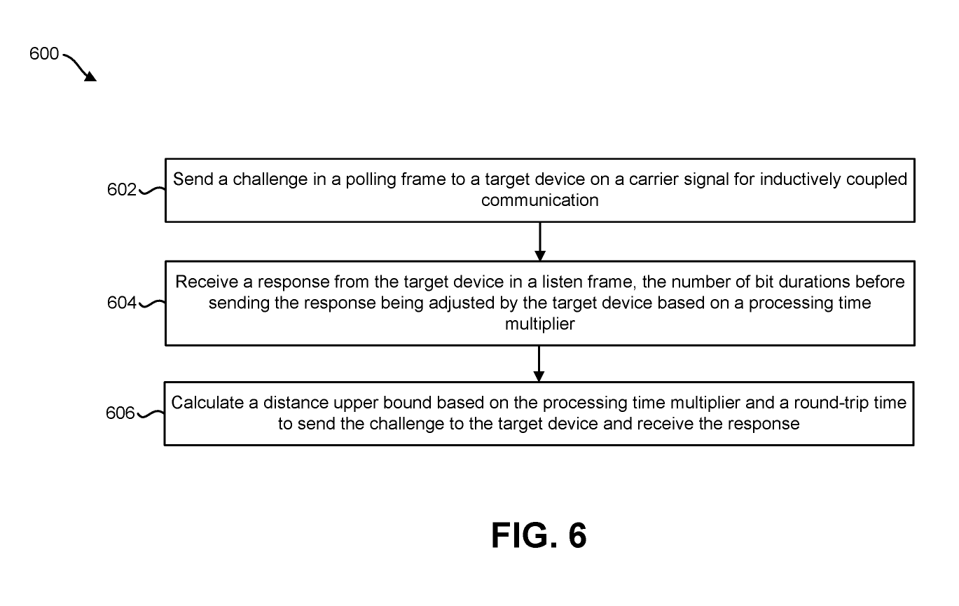

FIG. 6 is a flow diagram illustrating another method 600 for distance bounding by a verifier device 102 using NFC. The method 600 may be performed by a verifier device 102 that is in communication with a target device 104. In an implementation, the verifier device 102 may be a reader device (e.g., reader/writer) and the target device 104 may be listening device (e.g., card). The method 600 is an implementation of the second approach for distance bounding using NFC described above.

The verifier device 102 may send 602 a challenge 108 in a polling frame 340 to a target device 104 on a carrier signal for inductively coupled communication. The inductively coupled communication may be near field communication (NFC).

The verifier device 102 may receive 604 a response 110 from the target device 104 in a listen frame 246. The target device 104 may adjust a number of bit durations 124 before sending the response 110 based on a processing time multiplier 128. In an implementation, the number of bit durations 124 corresponds to a frame delay time (FDT) 342 before the listen frame 346. The response 110 may occur in a bit grid defined by the verifier device 102. The response 110 may be delayed while adhering to the rules of NFC type-A (NFC-A).

Load modulation of the response 110 may occur in the listen frame 346 after the number of bit durations 124 indicated by the processing time multiplier 128. Therefore, load modulation for the response 110 may be shifted by the number of bit durations 124 indicated by the processing time multiplier 128.

The verifier device 102 may calculate 606 a distance upper bound 134 based on the processing time multiplier 128 and a round-trip time 112 to send the challenge 108 to the target device 104 and receive the response 110. This may be accomplished as described in connection with FIG. 1.

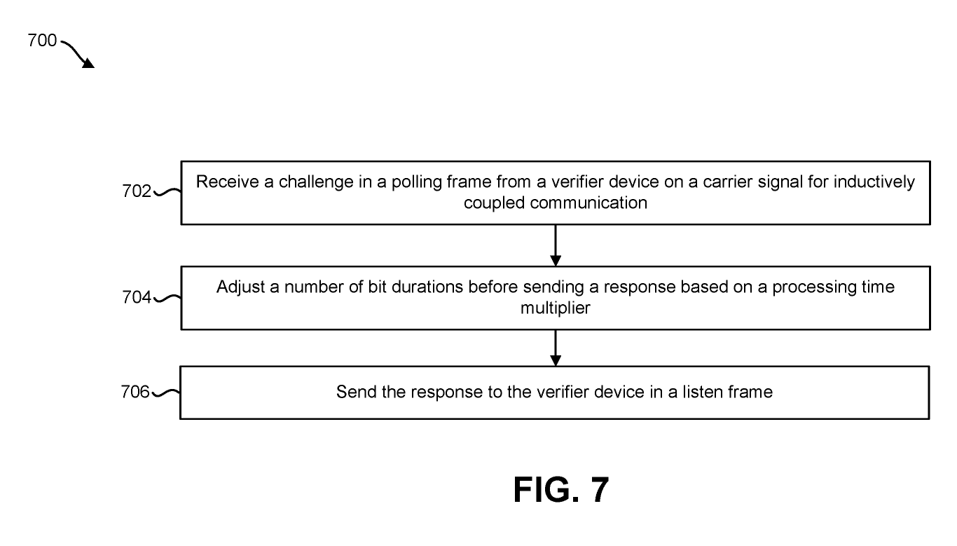

FIG. 7 is a flow diagram illustrating another method 700 for distance bounding by a target device 104 using NFC. The method 700 may be performed by a target device 104 that is in communication with a verifier device 102. In an implementation, the verifier device 102 may be a reader device (e.g., reader/writer) and the target device 104 may be listening device (e.g., card). The method 700 may be an implementation of the second approach for distance bounding using NFC described above.

The target device 104 may receive 702 a challenge 108 in a polling frame 340 from a verifier device 102 on a carrier signal for inductively coupled communication. The inductively coupled communication may be near field communication (NFC).

The target device 104 may adjust 704 a number of bit durations 124 before sending a response 110 based on a processing time multiplier 128. Load modulation for the response 110 may be shifted by the number of bit durations 124 indicated by the processing time multiplier 128.

The target device 104 may send 706 a response 110 to the verifier device 102 in the listen frame 346. For example, the target device 104 may start load modulation of the response 110 in the listen frame 346 after the number of bit durations 124 indicated by the processing time multiplier 128.

FIG. 8 is a sequence diagram illustrating an approach for calculating transit time 854 according to the described systems and methods. In this example, a verifier device 802 communicates with a target device 804. The verifier device 802 may be implemented in accordance with the verifier device 102 of FIG. 1. The target device 804 may be implemented in accordance with the target device 104 of FIG. 1. The verifier device 802 may be a reader device (e.g., reader/writer) and the target device 804 may be a listening device (e.g., card).

The verifier device 802 may measure a first round-trip time 812a (T_{round,1}) for an exchange of a first challenge 108 and a first response 110. To measure the first round-trip time 812a, the verifier device 802 may send 801 the first challenge 108 to the target device 804. The amount of time for the first challenge 108 to arrive at the target device 804 is the transit time 854a (T_{f}).

The target device 804 may start processing 803 the challenge 108. The amount of time to process the challenge 108 and generate a response 110 is the processing time 826 (T_{proc}). The target device 804 may send 805 the first response 110 back to the verifier device 802. The amount of time for the first response 110 to arrive at the verifier device 802 is the transit time 854b (T_{f}).

The verifier device 802 may measure a second round-trip time 812b (T_{round,2}) for an exchange of a second challenge 108 and a second response 110. The verifier device 802 may send 807 the second challenge 108 to the target device 804. The amount of time for the second challenge 108 to arrive at the target device 804 is the transit time 854c (T_{f}).

The target device 804 may delay 809 processing the second challenge 108 based on a processing time multiplier 128 (n). This may be accomplished according to the first approach and/or the second approach described in connection with FIG. 1. In the first approach, the target device 804 may vary the number of carrier cycles to the start of load modulation 120 within a tolerance window 116. In the second approach, the target device 804 may vary the number of bit durations 124, which has the effect of shifting the load modulation for the response 110 by a number of bit positions.

In this example, the processing time multiplier 128 (n) equals 2. Therefore, the target device 804 scales the processing time 826 by a multiple of 2 before responding to the second challenge 108. In other words, the target device 804 delays its response 110 by twice its internal processing delay.

After the processing delay, the target device 804 may send 811 a second response 110 to the verifier device 802. The amount of time for the second response 110 to arrive at the verifier device 802 is the transit time 854d (T_{f}).

Once again, assuming the distance 106 between the verifier device 802 and the target device 804 has not changed, the transit times 854a-d (T_{f}) are the same.

The verifier device 802 now has two different round-trip times 812. The verifier device 802 may determine the transit time measurement 132 according to Equation (5). In this case, the processing time multiplier 128 (n) is 2. It should be noted that the transit time measurement 132 does not require that the verifier device 802 know the actual processing time 826 of the target device 804.

In this example, T_{round,1}=T_{proc}+2·T_{f} and T_{round,2}=2·T_{proc}+2˜T_{f}. So 2·T_{round,1}=2˜T_{proc}+4·T_{f}. Therefore, 2·T_{round,1}−T_{round,2}=2T_{f}. This gives T_{f}=(2˜T_{round,1}−T_{round,2})/2.

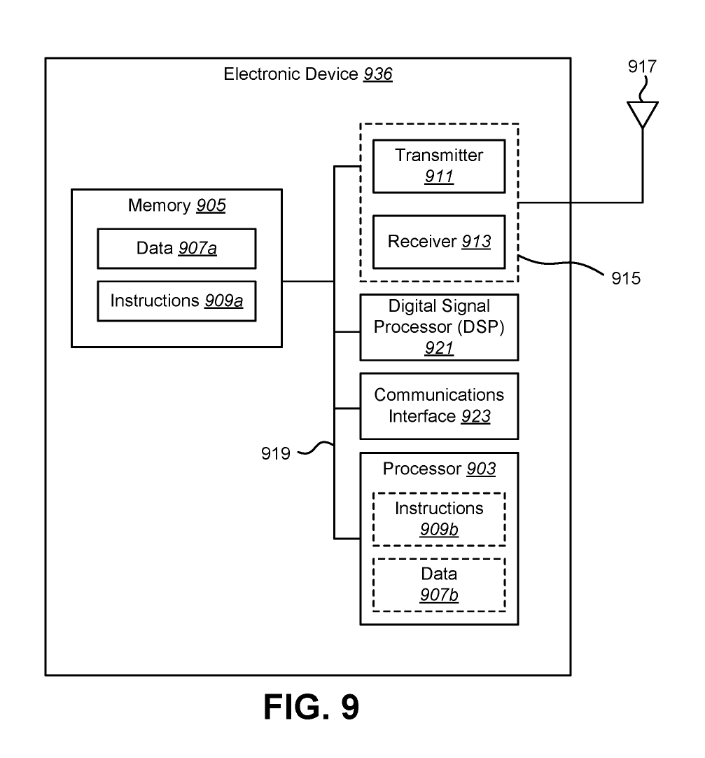

FIG. 9 illustrates certain components that may be included within an electronic device 936. The electronic device 936 may be an access terminal, a mobile station, a user equipment (UE), etc. For example, the electronic device 936 may be the verifier device 102 or the target device 104 of FIG. 1.

The electronic device 936 includes a processor 903. The processor 903 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 903 may be referred to as a central processing unit (CPU). Although just a single processor 903 is shown in the electronic device 936 of FIG. 9, in an alternative configuration, a combination of processors (e.g., an ARM and DSP) could be used.

The electronic device 936 also includes memory 905 in electronic communication with the processor (i.e., the processor can read information from and/or write information to the memory). The memory 905 may be any electronic component capable of storing electronic information. The memory 905 may be configured as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 907a and instructions 909a may be stored in the memory 905. The instructions may include one or more programs, routines, sub-routines, functions, procedures, code, etc. The instructions may include a single computer-readable statement or many computer-readable statements. The instructions 909a may be executable by the processor 903 to implement the methods disclosed herein. Executing the instructions 909a may involve the use of the data 907a that is stored in the memory 905. When the processor 903 executes the instructions 909, various portions of the instructions 909b may be loaded onto the processor 903, and various pieces of data 907b may be loaded onto the processor 903.

The electronic device 936 may also include a transmitter 911 and a receiver 913 to allow transmission and reception of signals to and from the electronic device 936 via an antenna 917. The transmitter 911 and receiver 913 may be collectively referred to as a transceiver 915. The electronic device 936 may also include (not shown) multiple transmitters, multiple antennas, multiple receivers and/or multiple transceivers.

The electronic device 936 may include a digital signal processor (DSP) 921. The electronic device 936 may also include a communications interface 923. The communications interface 923 may allow a user to interact with the electronic device 936.

The various components of the electronic device 936 may be coupled together by one or more buses, which may include a power bus, a control signal bus, a status signal bus, a data bus, etc. For the sake of clarity, the various buses are illustrated in FIG. 9 as a bus system 919.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 4-7 can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method, by a target device, for determining when to delay sending a response for distance bounding, comprising:
receiving a challenge in a polling frame from a verifier device on a carrier signal for inductively coupled communication;
delaying a response adhering to rules of NFC type-A using a processing time multiplier; and
sending the response to the verifier device in a listen frame.

2. The method of claim 1, wherein delaying the response using a processing time multiplier comprises delaying a start of load modulation of the carrier signal within a tolerance window of the listen frame based on the processing time multiplier.

3. The method of claim 2, wherein the start of load modulation is delayed by a number of carrier cycles corresponding to the processing time multiplier.

4. The method of claim 3, wherein the processing time multiplier is a number of carrier cycles that the target device delays the start of load modulation of the response.

5. The method of claim 2, wherein the tolerance window is a frame delay time (FDT) delta.

6. The method of claim 2, wherein the response starts within the tolerance window beginning at a bit boundary defined by the verifier device.

7. The method of claim 1, wherein delaying the response using a processing time multiplier comprises adjusting a number of bit durations before sending the response based on the processing time multiplier.

8. The method of claim 7, wherein load modulation of the response occurs in the listen frame after the number of bit durations indicated by the processing time multiplier.

9. The method of claim 7, wherein load modulation of the response is shifted by the number of bit durations indicated by the processing time multiplier.

10. The method of claim 7, wherein the number of bit durations corresponds to a frame delay time (FDT) before the listen frame.

11. The method of claim 7, wherein the response occurs in a bit grid defined by the verifier device.

12. The method of claim 1, wherein the inductively coupled communication is near field communication (NFC).

13. A target device configured to determine when to delay sending a response for distance bounding, comprising:
a processor;
a memory in communication with the processor; and
instructions stored in the memory, the instructions executable by the processor to:
receive a challenge in a polling frame from a verifier device on a carrier signal for inductively coupled communication;
delay a response adhering to rules of NFC type-A using a processing time multiplier; and
send the response to the verifier device in a listen frame.

14. The target device of claim 13, wherein the instructions executable to delay the response using a processing time multiplier comprise instructions executable to delay a start of load modulation of the carrier signal within a tolerance window of the listen frame based on the processing time multiplier.

15. The target device of claim 14, wherein the start of load modulation is delayed by a number of carrier cycles corresponding to the processing time multiplier.

16. The target device of claim 13, wherein the instructions executable to delay the response using a processing time multiplier comprise instructions executable to adjust a number of bit durations before sending the response based on the processing time multiplier.

17. The target device of claim 16, wherein load modulation of the response occurs in the listen frame after the number of bit durations indicated by the processing time multiplier.

18. A method for distance bounding by a verifier device, comprising:
sending a challenge in a polling frame to a target device on a carrier signal for inductively coupled communication;
receiving a response from the target device in a listen frame, wherein the target device delays the response adhering to rules of NFC type-A using a processing time multiplier; and
calculating a distance upper bound based on the processing time multiplier and a round-trip time to send the challenge to the target device and receive the response.

19. The method of claim 18, wherein the target device delays a start of load modulation of the carrier signal within a tolerance window of the listen frame based on the processing time multiplier.

20. The method of claim 19, wherein the target device delays the start of load modulation by a number of carrier cycles corresponding to the processing time multiplier.

21. The method of claim 19, wherein the processing time multiplier is a number of carrier cycles that the target device delays the start of load modulation of the response.

22. The method of claim 18, wherein the target device adjusts a number of bit durations before sending the response based on the processing time multiplier.

23. The method of claim 22, wherein load modulation of the response occurs in the listen frame after the number of bit durations indicated by the processing time multiplier.

24. The method of claim 22, wherein load modulation for the response is shifted by the number of bit durations indicated by the processing time multiplier.

25. A verifier device configured for distance bounding, comprising:
a processor;
a memory in communication with the processor; and
instructions stored in the memory, the instructions executable by the processor to:
send a challenge in a polling frame to a target device on a carrier signal for inductively coupled communication;
receive a response from the target device in a listen frame, wherein the target device delays the response adhering to rules of NFC type-A using a processing time multiplier; and
calculate a distance upper bound based on the processing time multiplier and a round-trip time to send the challenge to the target device and receive the response.

26. The verifier device of claim 25, wherein the target device delays a start of load modulation of the carrier signal within a tolerance window of the listen frame based on the processing time multiplier.

27. The verifier device of claim 26, wherein the target device delays the start of load modulation by a number of carrier cycles corresponding to the processing time multiplier.

28. The verifier device of claim 26, wherein the processing time multiplier is a number of carrier cycles that the target device delays the start of load modulation of the response.

29. The verifier device of claim 25, wherein the target device adjusts a number of bit durations before sending the response based on the processing time multiplier.

30. The verifier device of claim 29, wherein load modulation of the response occurs in the listen frame after the number of bit durations indicated by the processing time multiplier.
